(19) United States
(12) Patent Application Publication
(10) Pub. No.: US 2025/0289294 A1
(43) Pub. Date: Sep. 18, 2025

(54) REFRIGERANT MODULE ASSEMBLY

(71) Applicant: HANON SYSTEMS, Daejeon (KR)

(72) Inventors: In Keun KANG, Daejeon (KR); Young Man KIM, Daejeon (KR); Kyeong Cheol LEE, Daejeon (KR); Jae Min LEE, Daejeon (KR); Chan Jin LEE, Daejeon (KR)

(21) Appl. No.: 18/858,549

(22) PCT Filed: Sep. 13, 2023
(86) PCT No.: PCT/KR2023/013727

§ 371 Date: Oct. 21, 2024

(30) Foreign Application Priority Data
Dec. 8, 2022 (KR) 10-2022-0170501

(51) Int. Cl. B60H 1/32; B60R 16/02

(52) U.S. Cl. CPC B60H 1/3229; B60R 16/0207

(57) ABSTRACT

A refrigerant module assembly according to an embodiment may include a refrigerant module in which a refrigerant performs heat exchange while flowing, a controller configured to control a valve and a sensor provided in the refrigerant module, and a mounting bracket coupled to the refrigerant module and the controller and configured to mount the refrigerant module and the controller in a vehicle body.

### TECHNICAL FIELD

The present invention relates to a refrigerant module assembly, and more particularly, to a refrigerant module assembly made by modularizing components, such as a heat exchanger and valves, into a single component.

### BACKGROUND ART

As development and research have been conducted on environmental-friendly technologies and alternative energy sources for replacing fossil raw materials, and electric vehicles and hybrid vehicles have been considered as most attractive fields in recent vehicle industries. Batteries are mounted in the electric vehicles and hybrid vehicles to provide driving power. The power of the battery is used not only to drive the vehicle, but also to cool or heat a vehicle interior.

When the battery is used as a heat source for cooling or heating the interior of the vehicle that provides driving power by using the battery, the traveling distance decreases to that extent. To solve this problem, a method of applying a thermal management system, which has been widely used as a domestic cooling or heating device in the related art, to the vehicle has been proposed.

For reference, the thermal management system refers to a process of absorbing low-temperature heat and transferring the absorbed heat to a high-temperature location. For example, the thermal management system implements a cycle in which a liquid fluid becomes a gaseous fluid by evaporating in an evaporator and absorbing heat from the surrounding, and the gaseous fluid becomes the liquid fluid by dissipating heat to the surrounding by means of a condenser. The application of the thermal management system to the electric or hybrid vehicle may advantageously ensure an insufficient heat source in a general air conditioning device in the related art.

In a modularized configuration of the current thermal management system for an electric vehicle, important components (a valve, an accumulator, a chiller, a condenser, an internal heat exchanger, a sensor, and the like) are connected by pipes in a partially modularized manner. The thermal management system for a vehicle includes a refrigerant module to which components, in which a refrigerant flows while performing heat exchange, are coupled, and a controller that is an integrated driver configured to allow valves and sensors of the refrigerant module to communicate with a high-level controller of the vehicle.

However, because the refrigerant module and the controller are mounted in the vehicle and spaced apart from each other, there is a problem in that the number of assembling processes is increased, and wiring for connecting the valves and the sensors in the refrigerant module to the controller.

### DISCLOSURE

### Technical Problem

An object of an embodiment of the present invention is to provide a refrigerant module assembly, in which a refrigerant module and a controller are mounted in a vehicle body by means of a mounting bracket, such that the number of assembling processes may be reduced, and a package may be advantageously configured.

Another object of the embodiment of the present invention is to provide a refrigerant module assembly, in which a refrigerant module and a controller are disposed adjacent to each other by means of a mounting bracket, which may shorten wiring for connecting valves and sensors of the refrigerant module and the controller.

Still another object of the embodiment of the present invention is to provide a refrigerant module assembly, in which a refrigerant module and a controller are disposed to be spaced apart from each other without a mounting bracket, which may prevent thermal conduction caused by a high temperature of the refrigerant module.

Technical problems to be solved by the present invention are not limited to the above-mentioned technical problems, and other technical problems, which are not mentioned above, may be clearly understood by those skilled in the art from the following descriptions.

### Technical Solution

A refrigerant module assembly according to an embodiment of the present invention may include a refrigerant module in which a refrigerant performs heat exchange while flowing, a controller configured to control a valve and a sensor provided in the refrigerant module, and a mounting bracket coupled to the refrigerant module and the controller and configured to mount the refrigerant module and the controller in a vehicle body.

The refrigerant module and the controller may be coupled to the mounting bracket and spaced apart from each other.

The mounting bracket may include: a first bracket coupled to one surface of the refrigerant module; and a second bracket connected to the first bracket while intersecting the first bracket and coupled to the controller.

The first bracket may include: a module coupling portion coupled to one surface of the refrigerant module; and a vehicle body coupling portion bent and extending from the module coupling portion and coupled to the vehicle body.

At least a part of the second bracket may be bent and coupled to at least two surfaces of the controller.

The controller may be coupled to the mounting bracket and disposed between the refrigerant module and the vehicle body.

The mounting bracket may be provided as a plurality of mounting brackets and coupled to one surface of the refrigerant module to mount the refrigerant module in the vehicle body.

An expansion valve, a direction switching valve, and a PT sensor may be disposed in the refrigerant module.

The refrigerant module assembly may further include: at least one sub-bracket coupled to one side of the refrigerant module and configured to fix the refrigerant module to the vehicle body.

The mounting bracket may include: a first bracket coupled to one surface of the refrigerant module; and a second bracket connected to the first bracket while intersecting the first bracket, and the controller may be coupled to the first bracket and the second bracket opposite to the side to which the refrigerant module is coupled.

The refrigerant module and the controller may be electrically connected by a wire unit.

The wire unit may include: a connector fastened to one side of the refrigerant module; and a plurality of wires branching off and extending from the connector and respectively connected to the valve and the sensor of the controller.

### Advantageous Effects

According to the embodiment of the present invention, the refrigerant module and the controller may be mounted in the vehicle body by means of the mounting bracket, such that the number of assembling processes may be reduced, and the package may be advantageously configured.

In addition, according to the embodiment of the present invention, the refrigerant module and the controller are disposed adjacent to each other by means of the mounting bracket, which may shorten wiring for connecting the valves and the sensors of the refrigerant module and the controller.

In addition, according to the embodiment of the present invention, the refrigerant module and the controller are disposed to be spaced apart from each other without the mounting bracket, which may prevent thermal conduction caused by a high temperature of the refrigerant module.

### DESCRIPTION OF DRAWINGS

FIG. 1 is a perspective view illustrating one surface of a refrigerant module assembly according to an embodiment of the present invention.

FIG. 2 is a perspective view illustrating the other surface of the refrigerant module assembly according to the embodiment of the present invention.

FIG. 3 is a perspective view illustrating one surface of a refrigerant module assembly according to another embodiment of the present invention.

FIG. 4 is a perspective view illustrating a state in which a controller is mounted in the refrigerant module assembly according to another embodiment of the present invention.

### MODE FOR INVENTION

The present invention may be variously modified and may have various embodiments, and particular embodiments illustrated in the drawings will be described in detail below. However, the description of the exemplary embodiments is not intended to limit the present invention to the particular exemplary embodiments, but it should be understood that the present invention is to cover all modifications, equivalents and alternatives falling within the spirit and technical scope of the present invention. In the description of the present invention, the specific descriptions of publicly known related technologies will be omitted when it is determined that the specific descriptions may obscure the subject matter of the present invention.

The terms such as “first” and “second” may be used to describe various constituent elements, but the constituent elements should not be limited by the terms. These terms are used only to distinguish one constituent element from another constituent element.

The terminology used herein is used for the purpose of describing particular example embodiments only and is not intended to be limiting. Singular expressions include plural expressions unless clearly described as different meanings in the context. In the present application, the terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

In addition, throughout the specification, when one constituent element is referred to as being “connected to” another constituent element, one constituent element can be “directly connected to” the other constituent element, and one constituent element can also be “indirectly connected to,” “physically connected to,” or “electrically connected to” the other element with other elements therebetween. Further, the constituent elements are defined as different names according to positions or functions thereof, but the constituent elements may be integrated.

Hereinafter, embodiments of a refrigerant module assembly according to the present invention will be described in detail with reference to the accompanying drawings. In the description of the exemplary embodiments with reference to the accompanying drawings, the same or corresponding constituent elements are assigned with the same reference numerals, and the repetitive description thereof will be omitted.

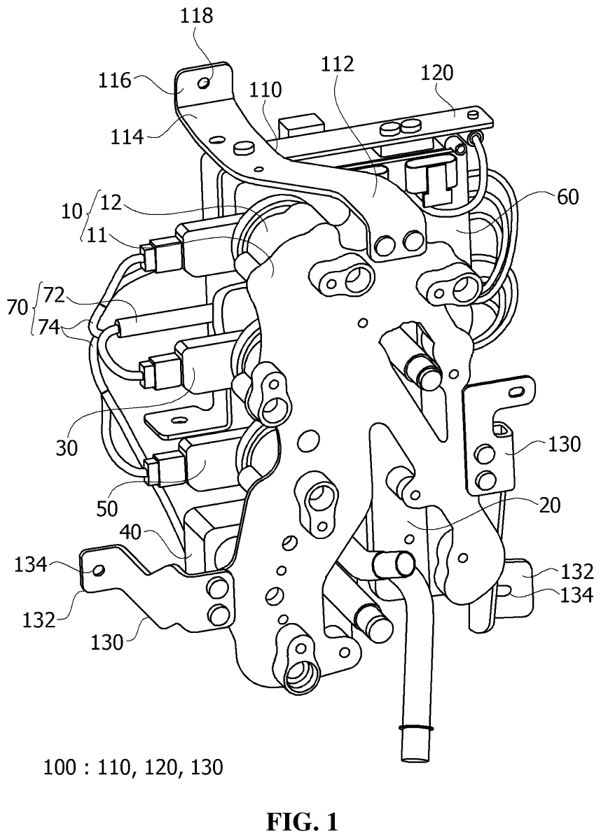

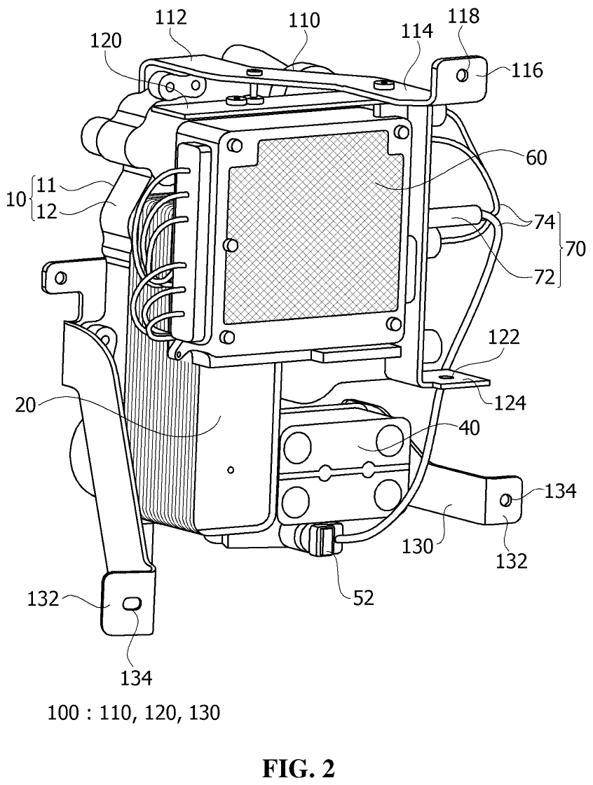

FIG. 1 is a perspective view illustrating one surface of a refrigerant module assembly according to an embodiment of the present invention, and FIG. 2 is a perspective view illustrating the other surface of the refrigerant module assembly according to the embodiment of the present invention.

As illustrated, a refrigerant module assembly according to an embodiment of the present invention may include a refrigerant module 10 in which a refrigerant performs heat exchange while flowing, a controller 60 configured to control a valve and a sensor provided in the refrigerant module 10, and mounting brackets 100 coupled to the refrigerant module 10 and the controller 60 and configured to mount the refrigerant module 10 and the controller 60 in a vehicle body.

The refrigerant module 10 has a plate shape in which a fluid flow path is formed approximately inside the refrigerant module 10, and the refrigerant module 10 has a predetermined thickness. In the refrigerant module 10, heat exchangers 20 and 40, which are heat exchange devices of a thermal management system, an expansion valve 50, and direction switching valves 30 and 32 are coupled and modularized, such that the number of processes of manufacturing products may be reduced, and the number of processes of the vehicle assembling line may be reduced. In addition, because the refrigerant module 10 simultaneously serves as a pipe, a fitting, and a housing, costs may be reduced, and workability may be improved.

The refrigerant module 10 may include an assembly including a bottom plate 11 and a top plate 12 and be manufactured by coupling the assembly by using brazing, a structural bonding agent (structural adhesive), a gasket, and the like. In addition, various materials, such as aluminum, thermoplastic plastic, or stainless steel, may be applied as a material of the refrigerant module 10 depending on manufacturing methods, purposes, and functions.

The bottom plate 11 is formed in a plate shape, and the top plate 12 is coupled to protrude, with a predetermined thickness, from one surface of the bottom plate 11, such that the fluid flow path is defined between the bottom plate 11 and the top plate 12.

A first heat exchanger 20 and a second heat exchanger 40, as heat exchange devices, are coupled to the refrigerant module 10. A refrigerant and a coolant may respectively pass through the first heat exchanger 20 and the second heat exchanger 40, thereby performing heat exchange.

In the present embodiment, a water-cooled condenser may be used as the first heat exchanger 20, and a chiller may be used as the second heat exchanger 40. The water-cooled condenser serves to condense a high-temperature, high-pressure gas-phase fluid (refrigerant), which is discharged from a compressor or an internal condenser into a high-pressure liquid by allowing the gas-phase fluid to exchange heat with an external heat source. The chiller refers to a device configured to be supplied with a low-temperature, low-pressure fluid and exchange heat with a coolant flowing along a coolant circulation line (not illustrated). The cool coolant, which has exchanged heat with the chiller, may circulate through the coolant circulation line and exchange heat with the battery.

The refrigerant discharged from the first heat exchanger 20 is introduced into a first direction switching valve 30. The first direction switching valve 30 serves to control a direction of the refrigerant discharged from the first heat exchanger 20. The refrigerant introduced into the first direction switching valve 30 may flow to an external heat exchanger (not illustrated). In a dehumidification mode, the refrigerant may move to a second direction switching valve 32 and then move to an evaporator (not illustrated).

The second heat exchanger 40 is supplied with the low-temperature, low-pressure refrigerant and exchanges heat with the coolant flowing along the coolant circulation line (not illustrated). The cool coolant, which has exchanged heat with the second heat exchanger 40, may circulate through the coolant circulation line and exchange heat with the battery. The refrigerant, which has exchanged heat with the external heat exchanger, is introduced into the expansion valve 50, and the refrigerant expanded in the expansion valve 50 is introduced into the second heat exchanger 40. The refrigerant, which has exchanged heat with the second heat exchanger 40, is discharged through a lower end and introduced into an accumulator (not illustrated).

With reference to FIG. 2, a PT sensor 52 for measuring a temperature and pressure of the refrigerant may be disposed in a low-temperature flow path through which the refrigerant discharged from the second heat exchanger 40 flows. The PT sensor 52 may be mounted on the top plate 12 together with the second heat exchanger 40 and sense a refrigerant state.

The controller 60 is an integrated driver configured to allow valves and sensors of the refrigerant module 10 to communicate with a high-level controller of the vehicle. The controller 60 is configured to control the above-mentioned valves (the expansion valve, the direction switching valve, and the like) and the sensors (the PT sensor). The controller 60 may be formed in an approximately flat rectangular parallelepiped shape. In the related art, the controller 60 is separately mounted and separated from the refrigerant module 10. However, in the present embodiment, the controller 60 and the refrigerant module 10 are mounted together in the vehicle body by means of the mounting bracket 100.

The refrigerant module 10 and the controller 60 may be electrically connected by a wire unit 70. The wire unit 70 may include a connector 72 fastened to one side of the refrigerant module 10, and wires 74 branching off and extending from the connector 72 and respectively connected to the valve and the sensor of the controller 60. In the present embodiment, because the refrigerant module 10 and the controller 60 are mounted together by means of the mounting bracket 100 and thus disposed to be close to each other, wiring constituting the wire unit 70 may be shortened, which may reduce an increase in costs of products.

The mounting brackets 100 may be provided as a plurality of mounting brackets 100. One end of the mounting bracket 100 may be coupled to one surface of the refrigerant module 10, and the other end of the mounting bracket 100 may be coupled to the vehicle body. Because the plurality of mounting brackets 100 are coupled to several portions of the vehicle body, the refrigerant module 10 may be stably mounted in the vehicle body.

The mounting brackets 100 may include a first bracket 110 coupled to one surface of the refrigerant module 10, and a second bracket 120 connected to the first bracket 110 while intersecting the first bracket 110 and coupled to the controller 60.

The first bracket 110 may include a module coupling portion 112 coupled to one surface of the refrigerant module 10, and a vehicle body coupling portion 114 bent and extending from the module coupling portion 112 and coupled to the vehicle body. In this case, the vehicle body coupling portion 114 is bent and extends from the module coupling portion 112, such that a connection portion of the vehicle body coupling portion 114 connected to the second bracket 120 is disposed at one side, thereby improving spatial efficiency. A bending portion 116 is bent from an end of the vehicle body coupling portion 114 so as to be in surface contact with the vehicle body. A fastening hole 118 is formed in the bending portion 116, and a fastening means, such as a screw, is fastened to the fastening hole 118.

The configuration in which the first bracket 110 includes the module coupling portion 112 and the vehicle body coupling portion 114 has been described above. However, the present invention is not limited thereto. The first bracket 110 may serve to mount the refrigerant module 10.

The second bracket 120 may be provided to couple the controller 60 and connected to the first bracket 110 while intersecting the first bracket 110. In the present embodiment, the second bracket 120 may be perpendicularly connected to the vehicle body coupling portion 114. When the second bracket 120 is coupled to the vehicle body in the state in which the second bracket 120 is connected to the first bracket 110 while intersecting the first bracket 110 as described above, the refrigerant module 10 and the controller 60 may be more stably mounted in the vehicle body. A bending portion 122 is bent from an end of the first bracket 120 so as to be in surface contact with the vehicle body. A fastening hole 124 is formed in the bending portion 122, and a fastening means, such as a screw, is fastened to the fastening hole 124.

At least a part of the second bracket 120 may be bent, such that at least two surfaces of the controller 60 may be coupled to the second bracket 120. As illustrated in the drawings, the first bracket 120 may be bent once in an approximately ‘¬’ shape, and an upper surface and one side surface of the controller 60 may be coupled to an inner surface of the first bracket 120. When the second bracket 120 is bent as described above, at least two surfaces of the controller 60 may be coupled, such that the controller 60 may be more securely mounted.

As described above, the refrigerant module 10 and the controller 60 may be respectively coupled to the first bracket 110 and the second bracket 120 and separately spaced apart from each other. When the refrigerant module 10 and the controller 60 may be coupled to be in contact with each other, the thermal conduction caused by the high-temperature fluid flowing through the refrigerant module 10 may be prevented, such that the performance in dissipating heat from the controller 60 may be improved.

In addition, the controller 60 may be coupled to the mounting bracket 100 and disposed between the refrigerant module 10 and the vehicle body. That is, when the second bracket 120 is coupled to the first bracket 110 and disposed between the refrigerant module 10 and the vehicle body, the controller 60 may be disposed between the refrigerant module 10 and the vehicle body. With this configuration, the refrigerant module 10 and the controller 60 may be disposed in a compact space, thereby improving component spatial efficiency in the vehicle body.

Meanwhile, a sub-bracket 130 may be coupled to one side of the refrigerant module 10 and fixed to the vehicle body. At least one sub-bracket 130 may be coupled to the refrigerant module 10. For example, as illustrated in the drawings, the sub-brackets 130 may be respectively coupled to a left lower portion and a right lower portion of the refrigerant module 10 to mount the refrigerant module 10 in the vehicle body. A bending portion 132 is bent from an end of the sub-bracket 130 so as to be in surface contact with the vehicle body. A fastening hole 134 is formed in the bending portion 132, and a fastening means, such as a screw, is fastened to the fastening hole 134.

With the use of the mounting bracket 100 described above, the refrigerant module 10 may be fixed in the vehicle body at a total of four points by means of the first bracket 110 and the sub-brackets 130, and the controller 60 is fixed to the vehicle body at one point by means of the second bracket 120, such that the refrigerant module 10 and the controller 60 may be stably mounted in the vehicle body.

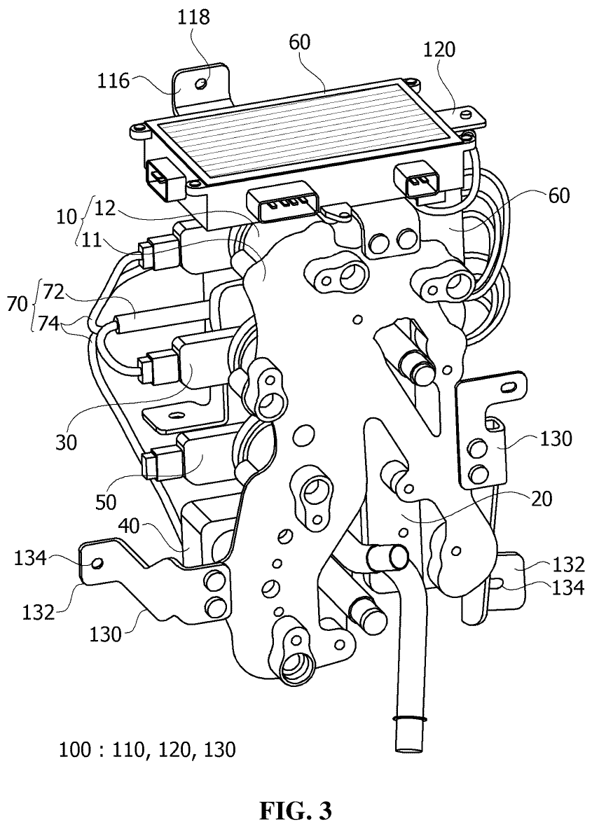

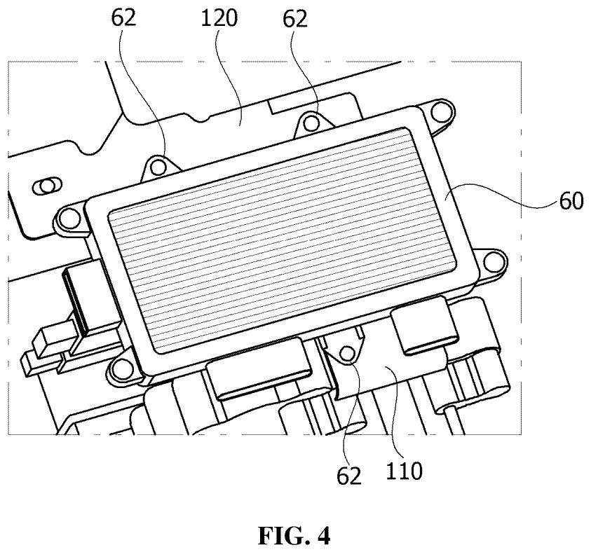

FIG. 3 is a perspective view illustrating one surface of a refrigerant module assembly according to another embodiment of the present invention, and FIG. 4 is a perspective view illustrating a state in which a controller is mounted in the refrigerant module assembly according to another embodiment of the present invention.

With reference to the drawings, the present embodiment is identical in most configurations to the above-mentioned embodiment but differs from the above-mentioned embodiment in terms of a position at which the controller 60 is disposed. In the present embodiment, the controller 60 may be disposed above the refrigerant module 10 without being disposed between the refrigerant module 10 and the vehicle body.

In this case, the controller 60 may be coupled to upper surfaces of the first bracket 110 and the second bracket 120 connected to and intersecting each other. That is, the controller 60 may be coupled to a side opposite to the first bracket 110 and the second bracket 120 to which the refrigerant module 10 is coupled.

When the controller 60 is coupled as described above, the controller 60 is spaced apart from the top plate 12, which is in a highest-temperature state in the refrigerant module 10. Therefore, it is possible to improve the heat dissipation performance and stably couple the controller 60 to the upper surface of the mounting bracket 100. In this case, the controller 60 may be fastened to the mounting bracket 100 by means of a plurality of controller fastening portions 62.

While the present invention has been described above with reference to the particular embodiments, it may be understood by those skilled in the art that the present invention may be variously modified and changed without departing from the spirit and scope of the present invention disclosed in the claims.

[Description of Reference Numerals]

| | |
|---|---|
| 10: Refrigerant module | 11: Bottom plate |
| 12: Top plate | 20: First heat exchanger |
| 30: First direction switching valve | 40: Second heat exchanger |
| 50: Expansion valve | 52: PT sensor |
| 60: Controller | 62: Controller fastening portion |
| 70: Wire unit | 72: Connector |
| 74: Wire | 100: Mounting bracket |
| 110: First bracket | 112: Module coupling portion |
| 114: Vehicle body coupling portion | 116: Bending portion |
| 118: Fastening hole | 120: Second bracket |
| 122: Bending portion | 124: Fastening hole |
| 130: Sub-bracket | 132: Bending portion |
| 134: Fastening hole | |

1. A refrigerant module assembly comprising:
a refrigerant module in which a refrigerant performs heat exchange while flowing;
a controller configured to control a valve and a sensor provided in the refrigerant module; and
a mounting bracket coupled to the refrigerant module and the controller and configured to mount the refrigerant module and the controller in a vehicle body.

2. The refrigerant module assembly of claim 1, wherein the refrigerant module and the controller are coupled to the mounting bracket and spaced apart from each other.

3. The refrigerant module assembly of claim 1, wherein the mounting bracket comprises:
a first bracket coupled to one surface of the refrigerant module; and
a second bracket connected to the first bracket while intersecting the first bracket and coupled to the controller.

4. The refrigerant module assembly of claim 3, wherein the first bracket comprises:
a module coupling portion coupled to one surface of the refrigerant module; and
a vehicle body coupling portion bent and extending from the module coupling portion and coupled to the vehicle body.

5. The refrigerant module assembly of claim 3, wherein at least a part of the second bracket is bent and coupled to at least two surfaces of the controller.

6. The refrigerant module assembly of claim 1, wherein the controller is coupled to the mounting bracket and disposed between the refrigerant module and the vehicle body.

7. The refrigerant module assembly of claim 1, wherein the mounting bracket is provided as a plurality of mounting brackets and coupled to one surface of the refrigerant module to mount the refrigerant module in the vehicle body.

8. The refrigerant module assembly of claim 1, wherein an expansion valve, a direction switching valve, and a PT sensor are disposed in the refrigerant module.

9. The refrigerant module assembly of claim 1, further comprising:
at least one sub-bracket coupled to one side of the refrigerant module and configured to fix the refrigerant module to the vehicle body.

10. The refrigerant module assembly of claim 1, wherein the mounting bracket comprises:
a first bracket coupled to one surface of the refrigerant module; and
a second bracket connected to the first bracket while intersecting the first bracket, and
wherein the controller is coupled to the first bracket and the second bracket opposite to the side to which the refrigerant module is coupled.

11. The refrigerant module assembly of claim 1, wherein the refrigerant module and the controller are electrically connected by a wire unit.

12. The refrigerant module assembly of claim 11, wherein the wire unit comprises:
a connector fastened to one side of the refrigerant module; and
a plurality of wires branching off and extending from the connector and respectively connected to the valve and the sensor of the controller.
